(19) United States
(12) Patent Application Publication
(10) Pub. No.: US 2003/0191579 A1
(43) Pub. Date: Oct. 9, 2003

(54) Travel route searching apparatus

(76) Inventors: Kiyomi Sakamoto, Ikoma (JP); Ikuo Terauchi, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/404,091

(22) Filed: Apr. 2, 2003

(30) Foreign Application Priority Data
Apr. 3, 2002 (JP) 2002-100963

(51) Int. Cl. G01C 21/26

(52) U.S. Cl. 701/202

(57) ABSTRACT

A travel route searching apparatus 1a includes at least a storage unit 11 and a processor 15. The storage unit 11 stores one or more pieces of travel point data including at least one travel point. The processor 15 selects one of the pieces of travel point data from the storage unit 11, and then obtains a start point and an end point that are required for a travel route search. Furthermore, the processor 15 obtains cartographic data of an area required for the travel route search, and then uses the obtained cartographic data to search for a travel route from the obtained start point via the travel point included in the selected travel point data selected to the obtained end point. Thus, it is possible to provide a travel route searching apparatus that requires only a small number of operations for designating travel points.

### BACKGROUND OF THE INVENTION

1. Field of the Invention

The present invention relates to travel route searching apparatuses and, more specifically, to an apparatus that searches for a route via at least one designated travel point to the destination.

2. Description of the Background Art

In recent years, there have been increasing demands for travel route searching apparatuses dedicated to special purposes, typified by delivery management and route sales, capable of searching for a route that allows an efficient travel of one or more selected points. An example of such conventional route searching apparatuses is disclosed in U.S. Pat. No. 2002/0,067,728 A1, which is described below.

The conventional travel route searching apparatus mainly includes a cartographic information storage unit, a site information receiving unit, a site information storage unit, a site-to-site information input unit, a site-to-site information storage unit, and an optimal route extracting unit. The cartographic information storage unit stores in advance cartographic information that includes information about time required for a user to travel along a road on a map. The site information receiving unit is supplied, via the Internet, with site information including one or more sites to be traveled. Such site information is generated by a user operating an input unit incorporated in a terminal device. Input site information is stored in the site information storage unit by the site information receiving unit. The site-to-site information input unit is supplied with site-to-site information including the current traffic conditions of the roads. The site-to-site information is stored in the point information storage unit by using the site-to-site information input unit. The optimal route extracting unit extracts a travel route that allows the user to efficiently travel the desired site(s) by using the cartographic information stored in the cartographic information storage unit, the site information stored in the site information storage unit, and the site-to-site information. The extraction results are reported to the user.

Traffic conditions, however, vary with time. Therefore, one travel route that is optimal at one time may not necessarily be optimal at another time, even though point information to be used for a route search includes the same point(s) to be traveled. Further, in the conventional travel route searching apparatus, the user has to always operate the input device to designate the point(s) to be traveled before he or she travels the same point(s) once traveled.

### SUMMARY OF THE INVENTION

Therefore, an object of the present invention is to provide a travel route searching apparatus that requires only a small number of operations for designating travel points.

In order to attain the object mentioned above, a first aspect of the present invention is directed to a travel route searching apparatus that includes: a point storage section for storing one or more pieces of travel point data each including at least one travel point; a data selecting section for selecting one of the pieces of travel point data stored in the point storage section; a first point obtaining section for obtaining a start point and an end point that are required for a travel route search; a cartographic data obtaining section for obtaining cartographic data of an area required for the travel route search; and a travel route searching section for searching, by using the cartographic data obtained by the cartographic data obtaining section, for a travel route from the start point obtained by the first point obtaining section via the travel point included in the travel point data selected by the data selecting section to the end point obtained by the first point obtaining section. As described above, in the travel route searching apparatus, one or more pieces of travel point data are stored in the point storage section, and one of these pieces is selected by the data selecting section. That is, only by selecting one piece of travel point data, the travel route searching apparatus can designate all travel points required for a travel route search. With this, it is possible to provide a travel route searching apparatus that requires only a small number of operations to be carried out by a user for designating travel points.

Also, the travel route searching apparatus further includes a second point obtaining section for obtaining a start point, an end point, and a travel point that are designated by a user for the travel route search; and a point data generating section for generating travel point data including the travel point obtained by the second point obtaining section. Furthermore, the point storage section stores the travel point data generated by the point data generating section. With this, the travel point data including travel points required by the user can be generated. Therefore, it is possible to provide a more user-friendly travel route searching apparatus.

Still further, the travel route searching apparatus further includes a receiving section for receiving traffic information representing current traffic conditions. Here, the travel route searching section searches for the travel route by further using the cartographic data obtained by the cartographic data obtaining section and the traffic information received by the receiving section. With this, it is possible to search for a travel route in consideration of traffic conditions at the time of travel route search.

The cartographic data obtaining section preferably obtains cartographic data represented by a plurality of links. Here, the travel route searching apparatus further includes a receiving section for receiving traffic information representing current traffic conditions; and a passage time calculating section for calculating a passage time required for a user to pass through each of the links obtained by the cartographic data obtaining section. Also, the travel route searching section searches for the travel route by further using the links each assigned with the passage time calculated by the passage time calculating section. With this, it is possible to search for a travel route in consideration of traffic conditions at the time of travel route search.

Still further, the travel route searching apparatus further includes a display section for displaying a travel route found by the travel route searching section.

Still further, in the travel route searching apparatus, the point storage section is incorporated in a storage medium, and the data selecting section, the point obtaining section, the cartographic data obtaining section, and the travel route searching section are incorporated in a main body.

Still further, the travel route searching apparatus further includes a due date storage section for storing a due related to the travel point data stored in the point storage section. Here, the data selecting section selects one of the pieces of travel point data from the point storage section by referring to the due stored in the due date storage section. With this, it is possible to prevent the user from not forgetting about going to a travel point included in the travel point data.

A second aspect of the present invention is directed to a storage medium used together with a travel route searching apparatus for searching for a route from a start point via a designated travel point to a destination. The storage medium includes: a control section for receiving one or more pieces of travel point data including at least one travel point; and a point storage section for storing the pieces of travel point data received by the control section. Here, the control section further reads the pieces of travel point data stored in the point storage section in response to a request from the travel route searching apparatus.

A third aspect of the present invention is directed to a travel route searching method including the steps of: selecting one of pieces of travel point data each including at least one travel point; obtaining a start point and an end point that are required for a travel route search; obtaining cartographic data of an area required for the travel route search; and searching, by using the cartographic data obtained in the cartographic data obtaining step, for a travel route from the start point obtained in the point obtaining step via the travel point included in the travel point data selected in the data selecting step to the end point obtained in the point obtaining step.

In the third aspect, the travel route searching method can be embodied as a computer program executable on a computer device. Furthermore, the computer program can be recorded on a recording medium.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating the hardware structure of a travel route searching apparatus 1a according to one embodiment of the present invention;

FIG. 2 is a schematic diagram exemplarily illustrating a road network represented by cartographic data CGD stored in a storage unit 11 of FIG. 1;

FIG. 3 is a schematic diagram illustrating the structure of the cartographic data CGD stored in the storage unit 11 of FIG. 1;

FIG. 4 is a schematic diagram illustrating a road network for use in known RVCS (Road to Vehicle Communication System) or VICS (Vehicle Information Communication System);

FIG. 5 is a schematic diagram illustrating the structure of traffic information TI received by a receiver 13 of FIG. 1;

FIG. 6 is a flow chart showing the procedure carried out by the travel route searching apparatus 1a illustrated in FIG. 1;

FIG. 7 is a schematic diagram illustrating the structure of travel point data TPD generated in step A4 of FIG. 6;

FIG. 8 is a flow chart showing the detailed procedure of step A8 of FIG. 6;

FIG. 9 is a schematic diagram illustrating a first estimate speed table FST held in the travel route searching apparatus 1a of FIG. 1;

FIG. 10 is a schematic diagram illustrating a second estimated speed table SST held in step A9 of FIG. 6;

FIGS. 11A and 11B are diagrams for describing travel route data TRD generated in step A9 of FIG. 6;

FIG. 12 is a block diagram illustrating the hardware structure of a travel route searching apparatus 1b according to a first modification of the present invention;

FIG. 13 is a flow chart showing the procedure carried out by the travel route searching apparatus 1b shown in FIG. 12;

FIG. 14 is a block diagram illustrating the hardware structure of a travel route searching apparatus 1c according to a second modification of the present invention;

FIG. 15 is a schematic diagram illustrating the structure of travel point data TPD stored in the storage unit 31 of FIG. 14; and

FIG. 16 is a flow chart showing the procedure carried out by a travel route searching apparatus 1c shown in FIG. 14.

### DESCRIPTION OF THE PREFERRED EMBODIMENT

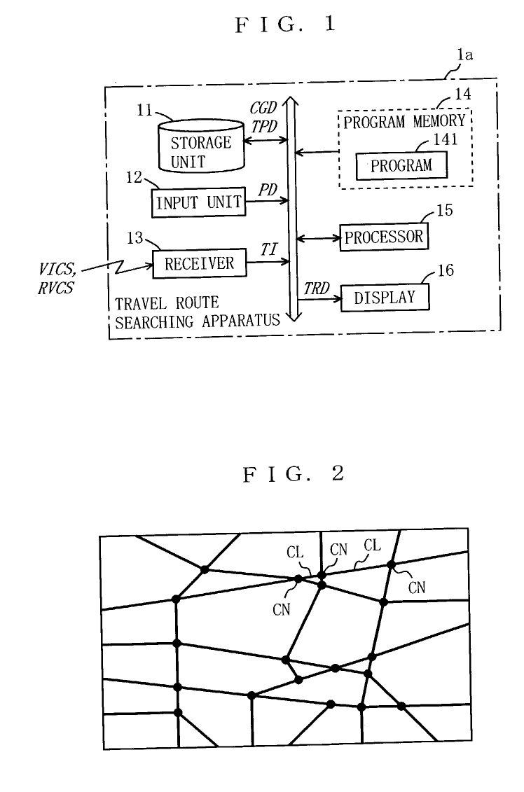

FIG. 1 is a block diagram illustrating the entire hardware structure of a travel route searching apparatus 1a according to one embodiment of the present invention. In FIG. 1, the travel route searching apparatus 1a includes a storage unit 11, an input unit 12, a receiver 13, a program memory 14, a processor 15, and a display 16.

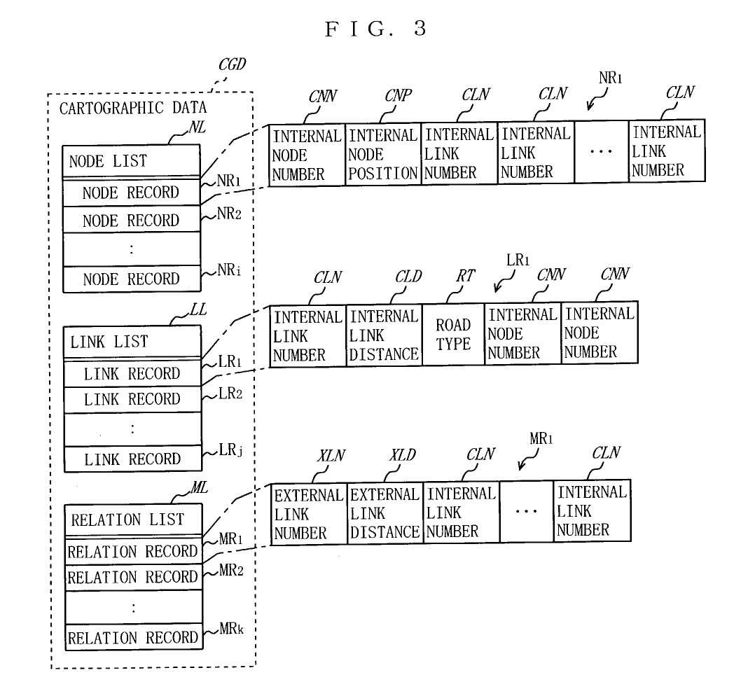

The storage unit 11 is a device that drives and randomly accesses a read/write recording medium for storing cartographic data CGD. The cartographic data CGD represents at least a road network on a wide-area map, such as the entire of Japan. Here, as illustrated in FIG. 2, the road network is mainly represented by i internal nodes CN (refer to black dots in FIG. 2) and j internal links CL. For the sake of convenience, FIG. 2 illustrates only three internal nodes CN and two internal links CL. Each internal node CN represents an intersection or a curve point on the network. Each internal link CL represents a road section connecting two internal nodes CN. In order to represent the above road network, the cartographic data CGD includes a node list NL and a link list LL, as illustrated in FIG. 3. The cartographic data CGD further includes a relation list ML, and the storage unit 11 further stores travel point data TPD. The relation list ML and the travel point data TPD will be described further below.

In FIG. 3, the node list NL includes node records NR₁ through NRᵢ, in a one-to-one correspondence with the i internal nodes CN. Each of the node records NR₁ through NRᵢ includes information about the internal node assigned thereto (such a node is hereinafter referred to as a target internal node) CN. Such internal node information includes an internal node number CNN, an internal node position CNP, and one or more internal link numbers CLN. In FIG. 3, the data structure of the node record NR₁ is exemplarily illustrated. The internal node number CNN is a number assigned to the target internal node CN for unique identification. The internal node position CNP specifies the position of the target internal node CL by using, for example, a latitude and a longitude. The internal link number(s) CLN set to each of the node record(s) NR₁ through NRi each specify one or more internal links CL connected to the target internal node CN.

The link list LL includes link records LR₁ through LRⱼ in a one-to-one correspondence with to the j internal links CL. Each of the link records LR₁ through LRⱼ includes information about the internal link assigned thereto (such a link is hereinafter referred to as a target internal link) CL. Such internal link information includes an internal link number CLN, an internal link distance CLD, a road type RT, and two internal node numbers CNN. In FIG. 3, the data structure of the link record NL₁ is exemplarily illustrated. The internal link number CLN is a number assigned to the target internal link CL for unique identification. The internal link distance CLD specifies a distance of a road section represented by the target internal link CL. The road type RT is typically a type of road represented by the target internal link CL. In the present embodiment, the road type RT is assumed to be any one of “national road”,“state road”, and “private road”, but this is not meant to be restrictive. The internal node numbers CNN set to each of the link records LR₁ through LRⱼ specify the internal nodes CN located at both ends of the target internal link CL.

In the present embodiment, each link record LR includes the internal link distance CLD. Alternatively, each link record LR may include a travel time. The travel time is an estimated time required for the user to pass through the target internal link CL at a predetermined speed.

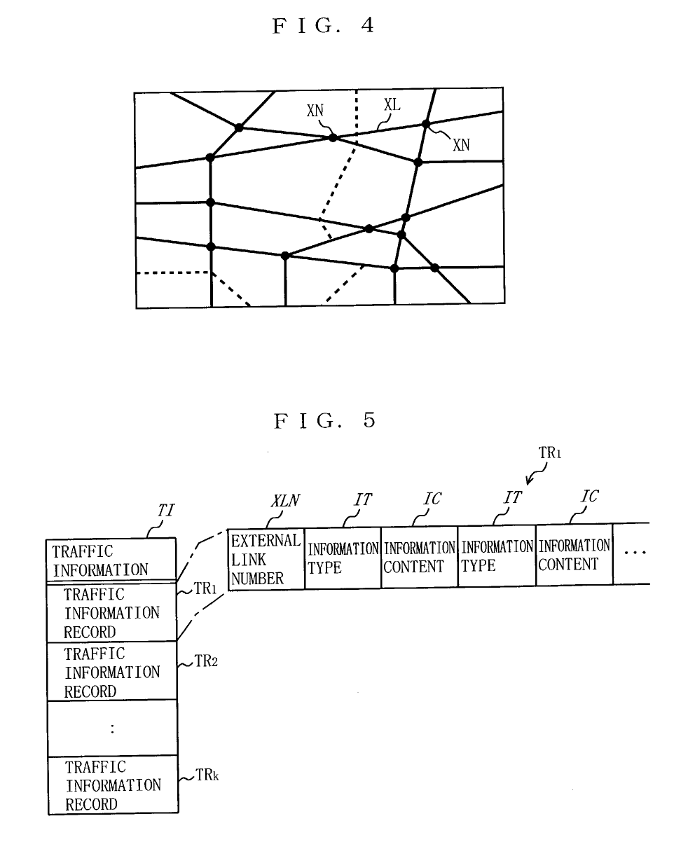

In association with the relation list ML, external links XL are described below. The receiver 13 of FIG. 1 is configured so as to be capable of regularly receiving traffic information TI from a Road to Vehicle Communication System (hereinafter referred to as RVCS) or a Vehicle Information Communication System (hereinafter referred to as VICS). In general, both system use networks, as illustrated in FIG. 4, which include only main or trunk roads represented by external nodes XN and the external links XL and do not include minor roads typified by narrow streets and alleys (refer to dotted lines). On the other hand, the road network represented by the above-described cartographic data CGD includes not only the main or trunk roads but also roads passable by the user (typically, minor roads). Therefore, the external links XL and the internal links CL are not necessarily in a complete one-to-one correspondence with each other. In other words, one external link XL may be identical to a single internal link CL, or may be a link composed of successive internal links CL. For example, FIG. 4 illustrates a road network covering the same area as that of FIG. 2, and each external link XL exemplarily illustrated in FIG. 4 is identical to a link constructed by two internal links CL illustrated in FIG. 2. For the purpose of indicating which internal links CL compose a single external link XL, the relation list ML is provided to the cartographic data CGD (refer to FIG. 3).

In FIG. 3, the relation list ML includes relation records MR₁ through MRₖ in a one-to-one correspondence with k external links XL. Each of the relation records MR₁ through MRₖ includes information about the external link assigned thereto (such a node is hereinafter referred to as a target external link) XN. Such external link information includes an external link number XLN, an external link distance XLD, and one or more internal link numbers CLN. In FIG. 3, the data structure of the relation record MR₁ is exemplarily illustrated. The external link number XLN is a number assigned to the target external link XL for unique identification. The external link distance XLD specifies a distance of a road section represented by the target external link XL. The internal link numbers CLN included in each relation record MR specify internal links CN that compose the target external link XL.

Note that the above-described relation list ML is not required if the external links XL are in a complete one-to-one correspondence with the internal links CL.

In FIG. 1, the input unit 12 may be implemented by a remote controller, a touch sensor, several keys, a mouse, a sound input unit, or any combination of two or more of the above. The user operates the input unit 12 to designate a search start point, a search end point, and one or more travel points for a travel route search, which will be described further below.

The receiver 13 receives, at regular time intervals, the traffic information TI indicative of current traffic conditions. The traffic information TI includes, as illustrated in FIG. 5, traffic information records TR₁ through TRₖ in a one-to-one correspondence with the k external links XL. Each of the traffic information records TR₁ through TRₖ includes the external link number XLN of the target external link XL, and several sets of an information type IT and an information content IC. In FIG. 5, the data structure of the traffic information record TR₁ is exemplarily illustrated. Here, by way of example, in order to represent a traffic congestion currently occurring on the target external link XL, one set includes an information type IT indicative of the occurrence of the traffic congestion and an information content IC indicative of a level of the traffic congestion (hereinafter referred to as a congestion level JL). The congestion level JL indicates a level of a traffic congestion occurring on a road section represented by the target external link XL. In the present embodiment, for the sake of convenience in description, the congestion level JL is assumed to be either one of two levels, “1” and “2”. This is not meant to be restrictive, however, and the congestion level JL may be either one of three or more levels.

The program memory 14 is typically implemented by ROM (Read Only Memory) for storing a computer program (hereinafter simply referred to as a program) 141. The processor 15 mainly performs a travel route search according to the program 141.

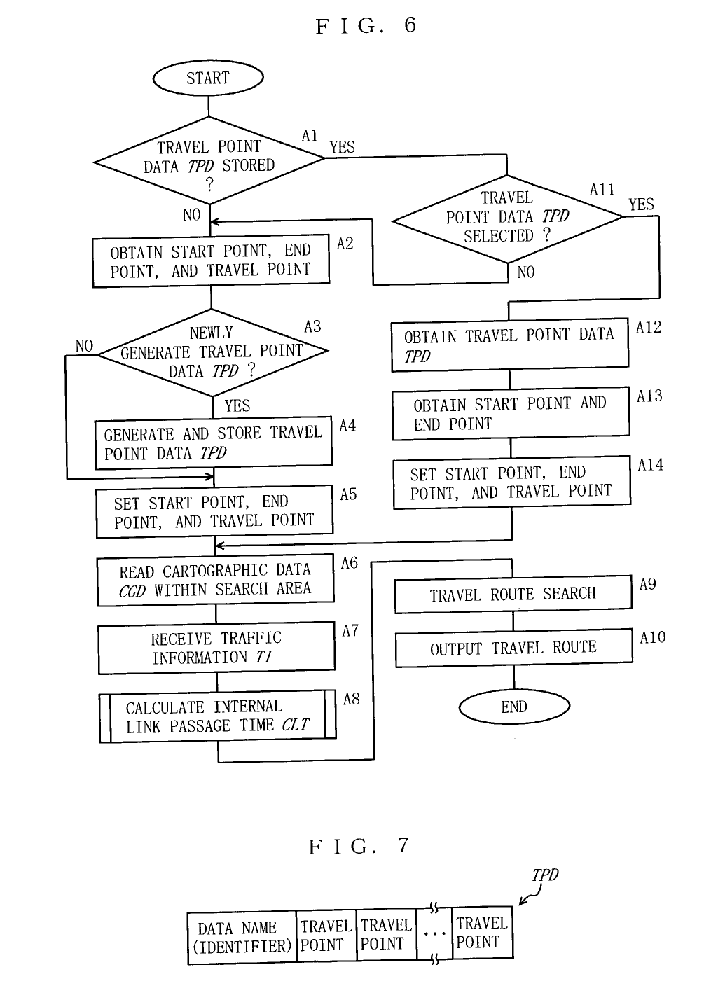

The operation of the above-structured travel route searching apparatus 1a is described below. FIG. 6 is a flow chart showing the procedure carried out by the travel route searching apparatus 1a. After starting the program 141, the processor 15 determines in step A1 whether any travel point data TPD has been stored in storage unit 11. If any travel point data TPD has been stored, the processor 15 performs step A11, which will be described further below. If no travel point data TPD has been stored, the processor 15 performs step A2.

In step A2, the processor 15 generates, in a working area not shown, image data that allows the user to designate a search start point, a search end point, and one or more travel points by using the input unit 12. The display 16 performs a display process based on the image data sent from the working area to prompt the user to designate a search start point, a search end point, and one or more travel points. The processor 15 obtains the search start point, the search end point, and the one or more travel points designated by the user viewing a screen provided on the display.

By way of example, when a user desires to update his or her driver's license in Japan, typical designated travel points would be a photo studio for shooting a picture for the driver's license, and a predetermined department of public safety (or police office). In another example, when a user desires to purchase his or her house, typical designated travel points would be a realtor, a financial institution dealing with a housing loan, and an agent office for paperwork tasks. In still another example, when a user desires shopping, such points would be various shops. In still another example, when a user goes on a trip, such points would be points that can be visited during the trip (typically, a museum, a shopping mall, a hotel, etc.)

In step A3, the processor 15 generates image data as described below in a working area. The image data is structured so that the user can designate, by using the input unit 12, whether to newly generate travel point data TPD, and a data name or an identifier for unique identification when such data is generated. The display 16 performs a display process based on the image data from the working area to prompt the user to choose whether to generate travel point data and, if any, a necessary data name or identifier. The processor 15 receives the user's choice and, if any, the necessary data name or identifier. If the user designates that such data generation is not required, the processor 15 skips step A4 to go to step A5. If the user designates that such data generation is required, the processor 15 performs step A4.

By way of example only, if the user designates travel points required for updating his or her driver's license, a data name “driver's license update” is provided to the travel point data TPD. If the user designates travel points required for purchasing his or her house, a data name “house purchasing” is provided. If the user designates various shops, a data name “shopping” is provided. If the user designates points that can be visited during the trip, a data name “trip” is provided.

In step A4, the processor 15 generates travel point data TPD including the data name or the identifier, and the received travel points on the working area, as illustrated in FIG. 7. The processor 15 then causes the generated travel point data TPD to be stored in the storage unit 11.

After step A3 or A4, the processor 15 sets the designated search start point, the search end point, and the entire travel points in the working area. In the next step A6, the processor 15 reads the cartographic data CGD of an area to be searched from the storage unit 11 to the working area. Here, the area to be searched is preferably an area including the designated search start point, the search end point, and the entire travel points. Thus, the node records NR of all internal nodes CN located in the area to be searched and the link records LR of all internal links CL located therein are read.

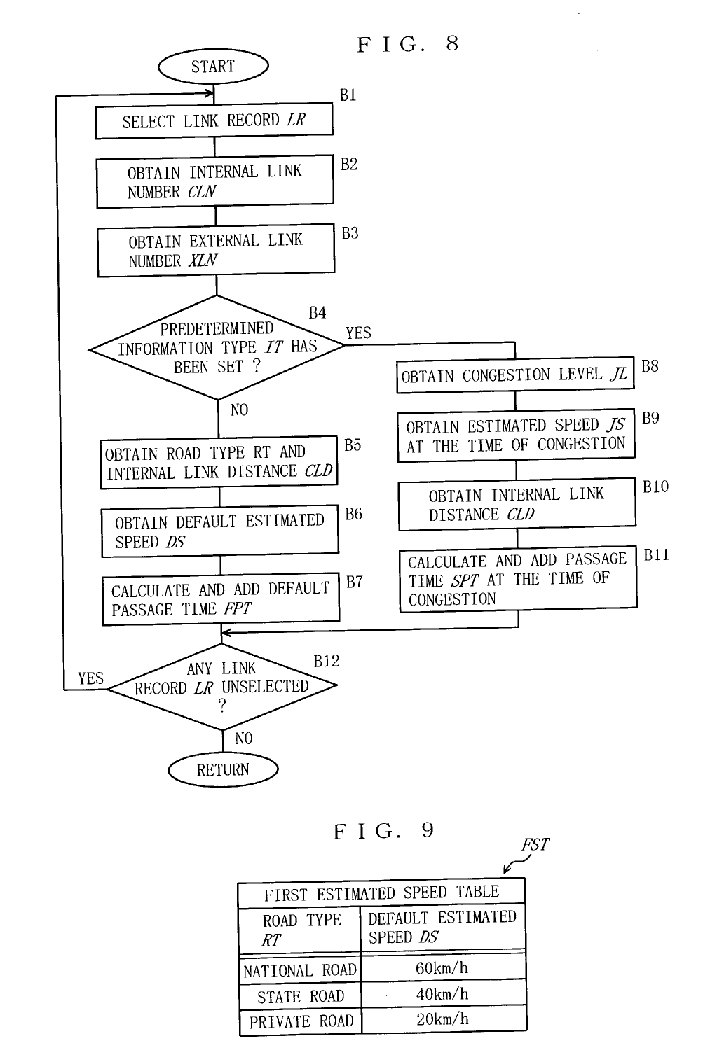

In the next step A7, under the control of the processor 15, the receiver 13 receives traffic information TI from RVCS or VICS for storage in the working area. In the next step A8, the processor 15 uses the traffic information TI stored in the working area to calculate an internal link passage time CLT for each of the read internal links CL. The internal link passage time CLT is an estimated time required for the user to pass through the relevant internal link CL under the current traffic conditions. FIG. 8 is a flow chart showing the detailed procedure of step A8.

In step B1 of FIG. 8, the processor 15 selects unselected one of all read link records LR (that is, the internal links CL).

In the next step B2, the processor 15 extracts the internal link number CLN from the selected link record LR.

In the next step B3, the processor 15 extracts the external link number XLN from the relation record MR including the extracted internal link number CLN in the relation list ML.

In the next step B4, the processor 15 determines, as to the received traffic information TI, whether the traffic information record TR including the extracted link number XLN includes the information type IT that has been set as being indicative of the occurrence of traffic congestion. If the information type IT has not been set as such, it can be regarded such that there is no traffic congestion on the selected internal link CL. Therefore, the processor 15 proceeds to step B5.

In step B5, the processor 15 extracts the road type RT and the internal link distance CLD from the selected link record LR.

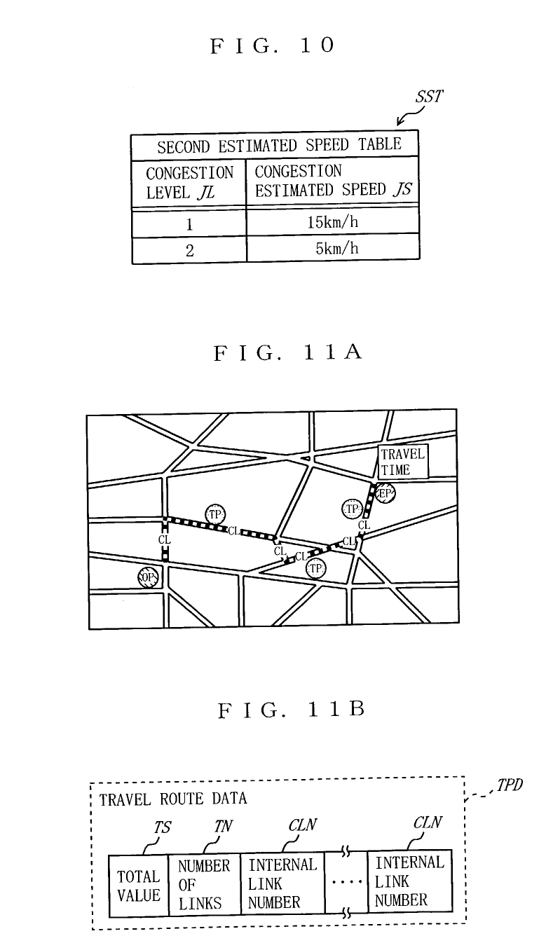

Here, as illustrated in FIG. 9, the travel route searching apparatus 1a stores in advance a first estimated speed table FST in the storage unit 11 or the program memory 14. The first estimated speed table FST describes sets of the road type RT and a default estimated speed DS. In FIG. 9, the road type RT the same as that described in the link record LR. Therefore, in the present embodiment, the road type RT to be described is any one of “national road”, “state road”, and “private road”. The default estimated speed DS is a predetermined estimated speed at which the user travels on a road falling within the category of the road type RT of the same set. By way of example only, the default estimated speed DS describes “60 km/h” for “national road”, “40 km/h” for “state road”, and “20 km/h” for “private road”.

In the next step B6, the processor 15 extracts the default estimated speed DS of the set including the extracted road type RT from the above-described first estimated speed table FST.

In the next step B7, the processor 15 divides the extracted internal link distance CLD by the extracted default estimated speed DS to calculate a default passage time FPT required for passing through the selected internal link CL. Here, the default passage time FPT is one type of internal link passage time CLT, the type indicative of an estimated time required for the user to pass through the selected internal link CL if there is no traffic condition thereon. Furthermore, in step B7, the processor 15 adds the calculated default passage time FPT to the selected link record LR.

As such, if it is determined in step B4 that there is no traffic congestion on the selected internal link CL, the processor 15 performs a process of steps B5 through B7 to calculate the default passage time FPT for the selected internal link CL.

If it is determined in step B4 that the information type IT has been set, it is regarded that traffic congestion has occurred on the selected internal link CL. Then, the processor performs step B8.

In step B8, the processor 15 extracts the information content IC of the set including the information type IT from the traffic information record TR.

In addition to the first estimated speed table FST, the travel route searching apparatus 1a further includes a second estimated speed table SST describing sets of the congestion level JL and an estimated speed JS at the time of congestion. In FIG. 10, the estimated speed JS at the time of congestion is a predetermined estimated speed required for the user to pass through a road at the congestion level JL of the same set. By way of example only, in the present embodiment, the estimated speed JS at the time of congestion describes “15 km/h” for the congestion level JL of “1”, and “5 km/h” for the congestion level JL of “2”.

In the next step B9, the processor 15 extracts the estimated speed JS at the time of congestion included in the same set as that of the extracted congestion level JL from the above-described estimated speed table SST.

In the next step B10, the processor 15 extracts the internal link distance CLD from the selected link record LR.

In the next B11, the processor 15 divides the extracted internal link distance CLD by the extracted estimated speed JS at the time of congestion to calculate a passage time SPT at the time of congestion required for passing through the selected internal link CL. Here, the passage time SPT at the time of congestion is another type of internal link passage time CLT, the type indicative of an estimated time required for the user to pass through the selected internal link CL if there is traffic condition thereon. Furthermore, in step B11, the processor 15 adds the calculated passage time SPT at the time of congestion to the selected link record LR.

As such, if it is determined in step B4 that traffic congestion has occurred on the selected internal link CL, the processor 15 performs a process of steps B8 through B11 to calculate the passage time SPT at the time of congestion for the selected internal link CL.

The processor 15 repeats the above process until it is determined in step B12 that there is no link record LR to be selected in B1. Thus, the processor 15 assigns the internal link passage time LT to every internal link CL in the area to be searched. Then, the processor 15 ends step A8 of FIG. 6.

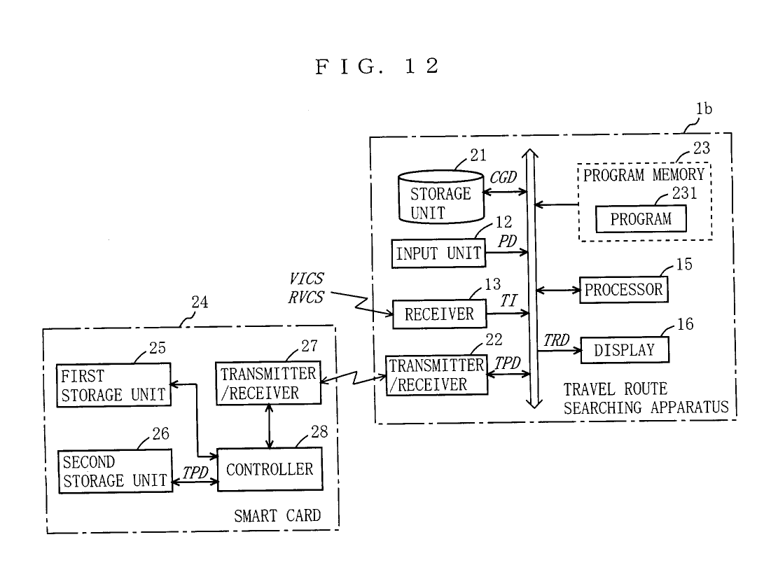

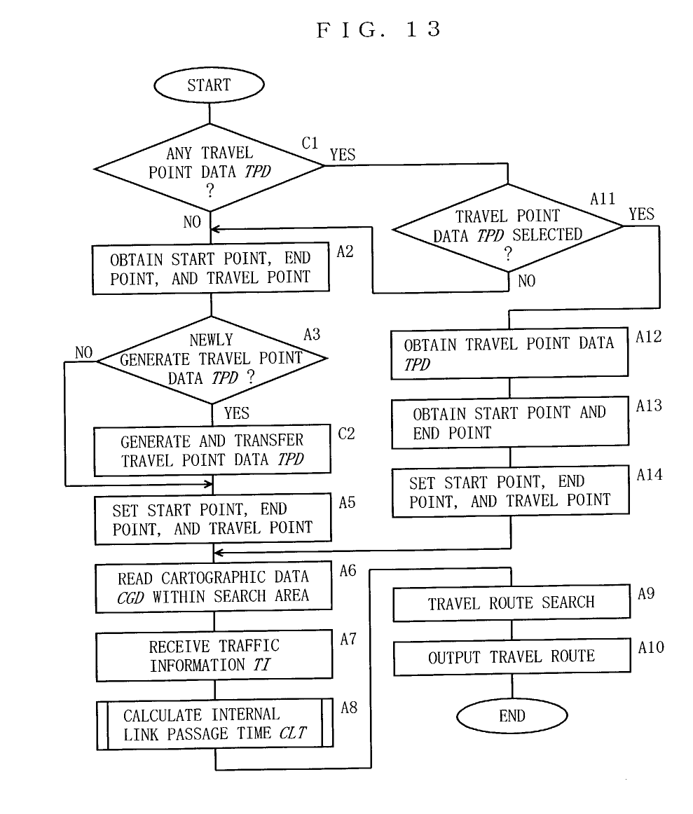

In step A9, the processor 15 performs a travel route search based on a scheme to which a neural network or a genetic algorithm is applied, or a solution typified by an annealing method or Dijkstra's algorithm. With such a travel route search, a travel route can be obtained which is assumed to allow the user to travel from the start point via the travel point(s) to the end point within a minimum travel time. More specifically, of possible routes from the starting point via the travel points to the end point, the travel route is one having a minimum total of the internal link passage times CLT assigned to internal links CL. For example, as illustrated in FIG. 11A, when a start point OP, an end point EP, and three travel points TP are set, a route composed of six internal links CL is found as the travel route.

Furthermore, the processor 15 generates and holds therein travel route data TRD for identifying the found travel route. As illustrated in FIG. 11B, the travel route data TRD includes, by way of example only, a total value TS, a number of links TN, and several internal link numbers CLN. The total value TS is a total of the internal link passage times CLT of the internal links CL composing the found travel route. The number of links TN is a total number of internal links CL composing the found travel route. The internal link numbers CLN identify the internal links CL composing the found travel route. In the travel route data TRD, the internal link numbers CLN are arranged preferably in the order of passing the corresponding internal links by the user, from one being closest to the start point to one being closest to the end point.

As described above, in the present embodiment, the travel route searching apparatus 1a uses the traffic information TI from RVCS or VICS to achieve a travel route search in consideration of the latest traffic conditions.

Returning to FIG. 6, in the next step A10, the processor 15 generates image data representing the travel road identified by the travel route data TRD (refer to FIG. 11A) on the working area. The display 16 performs a display process based on the image data from the working area to provide the user with the found travel route. Note that, in step A10, the processor 15 preferably generates image data representing an image having the travel route superimposed on a map of an area including the start point, the travel point(s), and the end point. Still preferably, the total value TS included in the travel route data TRD is superimposed in the vicinity of the travel route as a travel time from the start point to the end point, as illustrated in FIG. 11A.

If it is determined in step Al that the travel point data TPD has been stored, the processor 15 generates, in step A11, image data. The image data is structured so that the user can choose, by using the input unit 12, whether there is any piece of travel point data TPD to be used from out of those stored in the storage unit 11 and that, if there is any, the user can designate the piece with the use of a data name or an identifier assigned thereto. The display 16 performs a display process based on the image data from the working area to prompt the user to choose whether there is any such piece of travel point data TPD and, if any, the necessary data name or identifier. The processor 15 receives the user's choice and, if any, the necessary data name or identifier. If there is no such piece of travel point data TPD to be used, the processor 15 performs step A2. If there are any such pieces to be used, the processor 15 performs step A2.

In step A12, the processor 15 retrieves the travel point data TPD designated in step A11 from the storage unit 11.

In step A13, the processor 15 generates image data as described below on the working area. The image data is structured so that the user can designate a search start point and a search end point by using the input unit 12. The display 16 performs a display process based on the image data from the working area to prompt the user to designate a search start point and a search end point. The processor 15 obtains the search start point and the search end point that have been designated by the user viewing a screen provided on the display.

In the next step A14, the processor 15 sets the obtained search start point and search end point, and all travel points included in the retrieved travel point data TPD in the working area. The processor 15 then performs a process of step A6 and thereafter.

As described above, according to the travel route searching apparatus 1a, the travel point data TPD including at least one travel point is stored in the storage unit 11. Furthermore, before a travel route search is started, the travel route searching apparatus 1a inquires to the user whether to use any piece of travel point data TPD stored in the storage unit 11. If any piece of travel point data TPD is designated by the user, the travel route searching apparatus 1a uses all travel points included in the designated travel point data TPD to perform the travel route search. Therefore, the user only designates the travel point data TPD so as to cause the travel route searching apparatus 1a to set therein the travel points. Therefore, the number of operations performed by the user to designate travel points can be reduced.

FIG. 12 is a block diagram illustrating the hardware structure of a travel route searching apparatus 1b according to a first modification of the present invention. In FIG. 12, the travel route searching apparatus 1b is similar to the travel route searching apparatus 1a of FIG. 1, but is different therefrom in that the storage unit 11 and the program memory 14 are replaced by a storage unit 21, a transmitter/receiver 22, and a program memory 23. In FIG. 12, components similar in structure to those of FIG. 1 are provided with the same reference numerals, and are not described herein.

The storage unit 21 is a device that drives and randomly-accesses a read/write recording medium for storing cartographic data CGD as described above.

The transmitter/receiver 22 transmits or receives data to or from a smart card 24, which is one example of a storage medium in claims.

The program memory 23 is typically implemented by ROM for storing a computer program (hereinafter simply referred to as a program) 231.

In the present modification, the smart card 24 is exemplarily used as an electronic driver's license including, as illustrated in FIG. 12, a first storage unit 25, a second storage unit 26, a transmitter/receiver 27, and a controller 28. In the first storage unit 25, a competent authority has written a user's name, birthday, photo, and signature, date of issuance of the electronic driver's license, expiration date, issuing country, and vehicle types the user can drive. In most cases, the user is not allowed to write any information in the first storage unit 25 or to delete the information already stored therein. The second storage unit 26, on the other hand, is configured to allow the user to write therein, and stores the above-described travel point data TPD. The transmitter/receiver 27 transmits the information stored in the first and second storage units 25 and 26 to the transmitter/receiver 22 or receives, from the transmitter/receiver 22, information to be stored in the second storage unit 26. The controller 28 controls processes of writing and reading information.

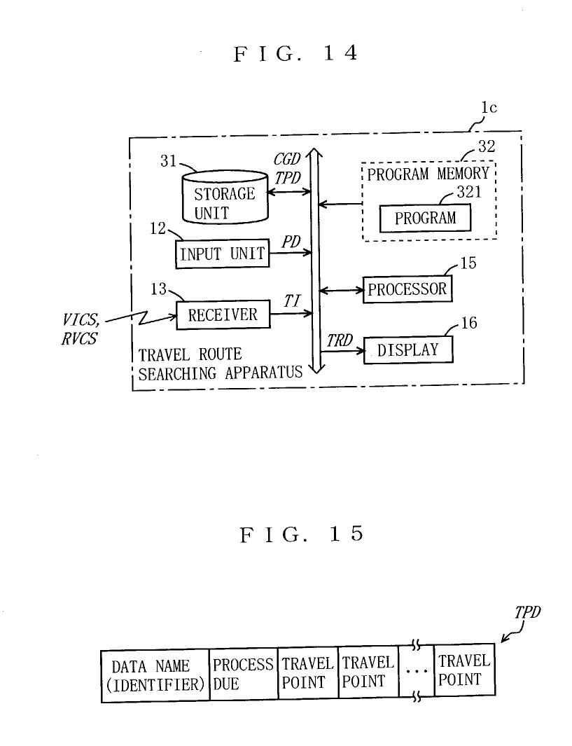

The operation of the above-structured travel route searching apparatus 1b is described below. FIG. 13 is a flow chart illustrating the procedure carried out by the travel route searching apparatus 1b. The flow chart of FIG. 13 is similar to that of FIG. 6, but is different therefrom in that steps A1 and A4 are replaced by steps C1 and C2. Therefore, in FIG. 13, steps equivalent to those in FIG. 6 are provided with the same step numbers, and are not described herein.

After the program 231 is started, the processor 15 transmits, in step C1, a request for the travel point data TPD via the transmitter/receiver 22 to the smart card 24, and then waits for a response to come from the smart card 24.

In the smart card 24, after receiving the request from the travel route searching apparatus 1b via the transmitter/receiver 27, the controller 28 checks to see whether any travel point data TPD has been stored in the second storage unit 24. If any travel point data TPD has been stored, the controller 28 generates a signal indicating as such. Also, the controller 28 reads all pieces of travel point data TPD stored in the second storage unit 24, and transmits both of the generated signal and the read pieces of travel point data TPD via the transmitter/receiver 27 to the travel route searching apparatus 1b. If no travel point data TPD has been stored, the controller 28 generates a signal indicating as such for transmission via the transmitter/receiver 27 to the travel route searching apparatus 1b.

In the travel route searching apparatus 1b, when it is determined in step C1 that the signal received by the transmitter/receiver 22 indicates that any travel point data TPD has been stored, the processor 15 performs step C3, which will be described further below. Conversely, when the signal indicates that no travel point data TPD has been stored, or when no signal has been received for a predetermined period of time after the transmission of the request, the processor 15 performs the above-described steps A2 and A3. For example, for route sales, the user designates, in step A2, customers' addresses as typical travel points. Then, in step A3, when the user does not require data generation, the processor 15 skips step C1 to proceed to step A5. Conversely, when the user requires data generation, the processor 15 performs step C2.

In step C2, the processor 15 generates the travel point data TPD as described above on the working area for transmission to the smart card 24. In the smart card 24, the controller 28 causes the travel point data TPD received via the transmitter/receiver 27 to be stored in the second storage unit 26. After step A3 or C1, the processor 15 performs steps A5 through A10 for providing the user with the travel route.

When it is determined in step C1 that any travel point data TPD has been stored, the transmitter/receiver 22 receives all pieces of travel point data TPD stored in the smart card 24. The processor 15 uses the received travel point data TPD received via the transmitter/receiver 22 to generate image data as described below on the working area. The image data is structured so that the user can choose, by using the input unit 12, whether there is any piece of travel point data TPD to be used from out of those received by the processor 15 and that, if there is any, the user can designate the piece with the use of a data name or an identifier assigned thereto. As with the above-described step A11, the processor 15 determines the presence or absence of the travel point data TPD for use and, when there is no such data, the processor 15 performs step A2. Conversely, when there is any, the processor 15 performs steps A12 and thereafter.

As described above, according to the travel route searching apparatus 1b according to the modification, the travel point data TPD including at least one travel point is stored in the smart card 24. Furthermore, the travel route searching apparatus 1b uses all travel points included in the travel point data TPD received from the smart card 24 and designated by the user to perform a travel route search. Therefore, the user only designates the travel point data TPD so as to cause the travel route searching apparatus 1b to set therein the travel points. Therefore, the number of operations performed by the user to designate travel points can be reduced.

Furthermore, the travel point data TPD can be private data to be protected, because what is stored therein is travel points the user desires to visit. According to the travel route searching apparatus 1b, the user can carry such travel point data TPD with the use of the smart card 24. Also, the user can use the travel point data TPD stored in the smart card 24 on another travel route searching apparatus 1b.

In the first modification, the travel route searching apparatus 1b merely performs a travel route search. This is not meant to be restrictive. For example, the travel route searching apparatus 1b may read the birthday or the expiration date of the electronic driver's license from the smart card 24, and may notify the user, predetermined days before the birthday or the expiration date, that the day is approaching.

Also, in the first modification, the travel point data TPD is stored in the smart card 24. This is not meant to be restrictive, and the travel point data TPD may be stored in any simple potable storage medium. In this case, the travel route searching apparatus 1b has to be provided with a reader for reading data from the portable storage medium instead of the transmitter/receiver 22.

FIG. 14 is a block diagram illustrating a travel route searching apparatus 1c according to a second modification of the above embodiment. In FIG. 14, the travel route searching apparatus 1c is similar to the travel route searching apparatus 1a of FIG. 1, but is different therefrom in that the storage unit 11 and the program memory 14 are replaced by a storage unit 31, and a program memory 32. In FIG. 14, components similar in structure to those of FIG. 1 are provided with the same reference numerals, and are not described herein.

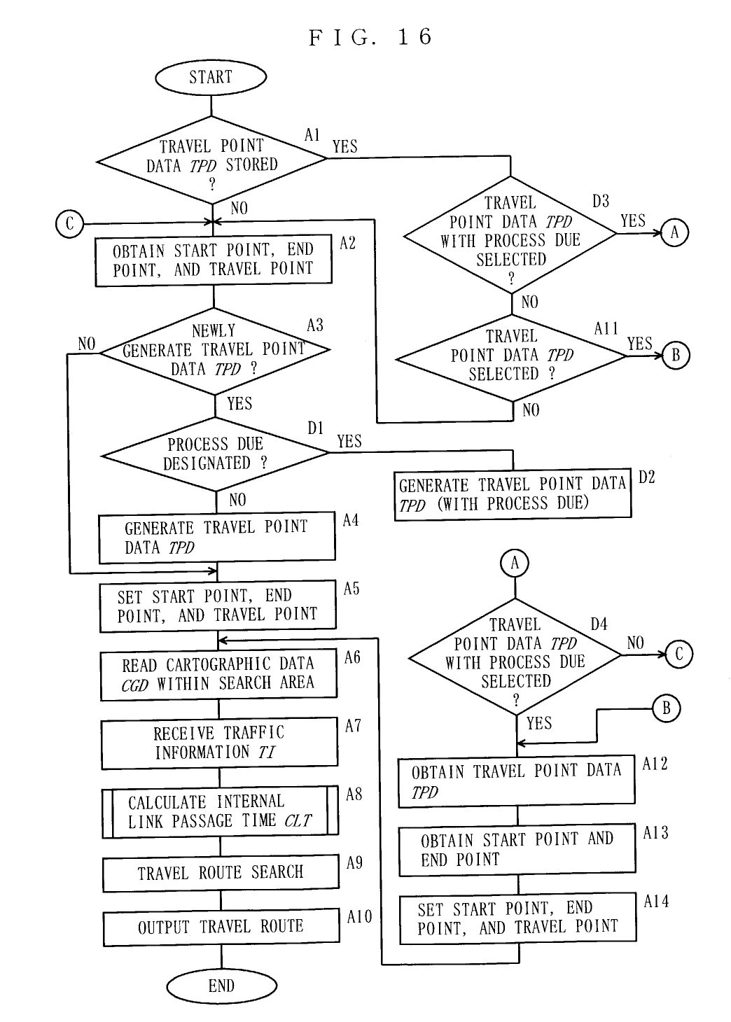

The storage unit 31 is a device that drives and randomly accesses a read/write recording medium for storing cartographic data CGD as described above and travel point data TPD unique to the second modification. As evident from the above-described embodiment, the travel route searching apparatus 1c may search for a travel route passing through travel points required for procedures performed by a predetermined due date. For the sake of convenience in such procedures, the travel point data TPD includes, as illustrated in FIG. 15, a process due as well as the data name or the identifier, and the travel point(s). The process due is a due date by which the relevant procedures have to be finished.

The program memory 32 is typically implemented by ROM for storing a computer program (hereinafter simply referred to as a program) 321.

The operation of the above-structured travel route searching apparatus 1c is described below. FIG. 16 is a flow chart showing the procedure carried out by the travel route searching apparatus 1c. The flow chart of FIG. 16 is similar to that of FIG. 6, but is different therefrom in that step A4 is replaced by steps D1 and D2, and that step D3 is further provided. Therefore, steps equivalent to those of FIG. 6 are provided with the same step numbers, and are not described herein.

After the program 321 stored in the program memory 32 is started and it is determined in step A3 that data generation is required, the processor 15 performs step D1. In step D1, the processor 15 generates image data as described below in a working area. The image data is structured so that the user can determine, by using the input unit 12, whether a process due is required to be designated and that the user further can designate the process due, if any. The display 16 performs a display process based on the image data from the working area to prompt the user to choose whether a process due is required and the process due if necessary. The processor 15 obtains the user's choice and, if any, the process due. If the user determines not to require a process due, the processor performs step A4. Conversely, if the user determines to require a process due, the processor 15 performs step D2. By way of example only, when the travel points required for updating the driver's license are designated, the expiration date described in the driver's license is designated.

In step D2, the processor 15 generates travel point data TPD on a working area. The generated travel point data TPD includes, as illustrated in FIG. 15, the extracted data name or identifier, the obtained process due, and the obtained travel points. The processor 15 then causes the generated travel point data TPD to be stored in the storage unit 11.

When it is determined in step A1 that any travel point data TPD has been stored, the processor 15 determines in step D3 whether there is any travel point data TPD added with the process due. If there is no such travel point data TPD, the processor 15 performs the above-described step A11. Conversely, if there is any, the processor 15 performs step D4.

In step D4, the processor 15 obtains a current date typically from a timepiece section (not shown) that keeps track of the current date. Furthermore, the processor 15 selects any travel point data TPD whose process due falls within a predetermined number of days from the current date. The processor 15 then generates image data as described below on the working area. The image data is structured so as to be able to display the process due for each selected piece of travel point data TPD. Also, the image data is structured so that the user can choose, by using the input unit 12, whether there is any piece of travel point data TPD to be used and that, if there is any, the user can designate the piece with the use of a data name or an identifier assigned thereto. The display 16 performs a display process based on the image data from the working area to prompt the user to choose whether there is any such piece of travel point data TPD added with the process due and, if any, the necessary data name or identifier. The processor 15 receives the user's choice and, if any, the necessary data name or identifier. If there is no such piece of travel point data TPD to be used, the processor 15 performs step A12. If there are any such pieces to be used, the processor 15 obtains in step A12 the designated piece of travel point data TPD.

As described above, according to the travel route searching apparatus 1c of the second modification, the travel point data TPD is set with the process due. Then, the travel route searching apparatus 1c warns the user of any procedure whose process due is approaching. Moreover, when the user selects the travel point data TPD including such a process due, the travel route searching apparatus 1c searches for a travel route passing through the travel points included in the selected travel point data TPD. With this, it is possible to prevent the user from not forgetting about going to a travel point included in the travel point data.

In the second modification, the process due is included in the travel point data TPD. This is not meant to be restrictive. Alternatively, the process due can be stored in a recording area other than the travel point data TPD, such as the smart card 24 described in the first modification.

In the second modification, the timepiece section typically keeps track of the current date, and the processor 15 obtains the current date from the timepiece section. This is not meant to be restrictive. Alternatively, the timepiece section may keep track of the current time, and the processor 15 obtains the current time from the timepiece section. In this case, the processor 15 further selects any travel point data TPD whose process due falls within a predetermined period of time from the current time.

In the foregoing descriptions, the travel route searching apparatuses 1a through 1b merely output a travel route. Alternatively, each travel route searching apparatus is structured to guide the user to the destination in accordance with the found travel route. In this case, the start point set in step A5 may be a user's current position that can be obtained from an autonomous navigation sensor and/or an external measuring system typified by GPS (Global Positioning System) incorporated in a general navigation device.

Furthermore, in the foregoing descriptions, the travel point data TPD includes a data name or an identifier, and one or more travel points. This is not meant to be restrictive. Alternatively, the travel point data TPD may further include the start point and the end point. Also, the travel point data TPD may be stored in a storage unit other than the storage unit 11 that stores the cartographic data CGD. Still further, the travel point data TPD is generated after step A3 in the foregoing descriptions. This is also not meant to be restrictive. For example, the travel point data TPD may be generated after the user operates a button that is provided on the input unit 12 or a display menu and is assigned with a function of generating the travel point data TPD.

Still further, in the foregoing descriptions, the information type IT can be set as being indicative of the occurrence of traffic congestion, and the information content IC can be set with the congestion level. This is not meant to be restrictive. The information type IT can be set as being indicative of a time of passing through the target external link XL. In this case, the information content IC is set with a time required for passing through the target external link XL under current conditions. With the use of the above-mentioned passage times, the travel route can be found.

Still further, in the foregoing descriptions, the travel route searching apparatuses 1a through 1c are preferably structured to be capable of accessing a communications network typified by the Internet. Thus, the user can obtain electronic documents required for procedures, typified by those for updating a driver's license, from a predetermined Web server.

While the invention has been described in detail, the foregoing description is in all aspects illustrative and not restrictive. It is understood that numerous other modifications and variations can be devised without departing from the scope of the invention.

What is claimed is:

1. A travel route searching apparatus, comprising:
a point storage section for storing one or more pieces of travel point data each including at least one travel point;
a data selecting section for selecting one of the pieces of travel point data stored in the point storage section;
a first point obtaining section for obtaining a start point and an end point that are required for a travel route search;
a cartographic data obtaining section for obtaining cartographic data of an area required for the travel route search; and
a travel route searching section for searching, by using the cartographic data obtained by the cartographic data obtaining section, for a travel route from the start point obtained by the first point obtaining section via the travel point included in the travel point data selected by the data selecting section to the end point obtained by the first point obtaining section.

2. The travel route searching apparatus according to claim 1, further comprising:
a second point obtaining section for obtaining a start point, an end point, and a travel point that are designated by a user for the travel route search; and
a point data generating section for generating travel point data including the travel point obtained by the second point obtaining section, wherein
the point storage section stores the travel point data generated by the point data generating section.

3. The travel route searching apparatus according to claim 1, further comprising:
a receiving section for receiving traffic information representing current traffic conditions, wherein
the travel route searching section searches for the travel route by further using the cartographic data obtained by the cartographic data obtaining section and the traffic information received by the receiving section.

4. The travel route searching apparatus according to claim 1, wherein
the cartographic data obtaining section obtains cartographic data represented by a plurality of links,
the travel route searching apparatus further comprises:
a receiving section for receiving traffic information representing current traffic conditions; and
a passage time calculating section for calculating a passage time required for a user to pass through each of the links obtained by the cartographic data obtaining section, and
the travel route searching section searches for the travel route by further using the links each assigned with the passage time calculated by the passage time calculating section.

5. The travel route searching apparatus according to claim 1, further comprising
a display section for displaying a travel route found by the travel route searching section.

6. The travel route searching apparatus according to claim 1, wherein
the point storage section is incorporated in a storage medium; and
the data selecting section, the point obtaining section, the cartographic data obtaining section, and the travel route searching section are incorporated in a main body.

7. The travel route searching apparatus according to claim 1, further comprising:
a due date storage section for storing a due related to the travel point data stored in the point storage section, wherein
the data selecting section selects one of the pieces of travel point data from the point storage section by referring to the due stored in the due date storage section.

8. A storage medium used together with a travel route searching apparatus for searching for a route from a start point via a designated travel point to a destination, the storage medium comprising:
a control section for receiving one or more pieces of travel point data including at least one travel point; and
a point storage section for storing the pieces of travel point data received by the control section, wherein
the control section further reads the pieces of travel point data stored in the point storage section in response to a request from the travel route searching apparatus.

9. A travel route searching method comprising the steps of:
selecting one of pieces of travel point data each including at least one travel point;
obtaining a start point and an end point that are required for a travel route search;
obtaining cartographic data of an area required for the travel route search; and
searching, by using the cartographic data obtained in the cartographic data obtaining step, for a travel route from the start point obtained in the point obtaining step via the travel point included in the travel point data selected in the data selecting step to the end point obtained in the point obtaining step.

10. The travel route searching method according to claim 9, being embodied as a computer program executable on a computer device.

11. The travel route searching method according to claim 10, wherein the computer program is recorded on a recording medium.
